(19) United States
(12) Patent Application Publication
(10) Pub. No.: US 2026/0142984 A1
(43) Pub. Date: May 21, 2026

(54) METHOD AND SYSTEM FOR STORING INTRUSION DETECTION RESULTS IN AN IN-VEHICLE NETWORK

(71) Applicants: HYUNDAI MOTOR COMPANY, Seoul (KR); KIA CORPORATION, Seoul (KR)

(72) Inventors: Seung Yeon Jeong, Hwaseong-si (KR); Jiyong Han, Hwaseong-si (KR)

(73) Assignees: HYUNDAI MOTOR COMPANY, Seoul (KR); KIA CORPORATION, Seoul (KR)

(21) Appl. No.: 19/253,381

(22) Filed: Jun. 27, 2025

(30) Foreign Application Priority Data
Nov. 18, 2024 (KR) 10-2024-0163785

(51) Int. Cl. H04L 9/40

(52) U.S. Cl. CPC H04L 63/1416

(57) ABSTRACT

A method of storing the intrusion detection results in an in-vehicle network includes detecting an intrusion into the in-vehicle network, identifying a priority for the detected intrusion, identifying a first area in a memory for storing logs for the detected intrusion based on the identified priority, assigning an ID to the detected intrusion, storing the logs for the detected intrusion in the identified first area in the memory based on the assigned ID, determining that the detected intrusion is terminated, and based on determining that the detected intrusion is terminated, terminating storage of the logs in the first area in the memory and storing result information on the detected intrusion and the ID in a second area in the memory.

### CROSS-REFERENCE TO RELATED APPLICATION

This application claims priority to and the benefit of Korean Patent Application No. 10-2024-0163785, filed on Nov. 18, 2024, the disclosure of which is incorporated herein by reference in its entirety.

### BACKGROUND

### 1. Technical Field

The present disclosure relates to a method and system for storing intrusion detection results in an in-vehicle network.

### 2. Discussion of Related Art

For the convenience and safety of drivers, many functions of vehicles that were previously controlled mechanically are now controlled by small computers called electronic control units. In addition, low-performance electronic control units are being replaced by high-performance electronic control units. As many functions are installed in vehicles and electronic control units are connected to each other and other electronic devices, various communication networks such as a controller area network (CAN), a local interconnect network (LIN), a FlexRay network, a Media Oriented System Transport (MOST) network, and an automotive Ethernet are included in vehicles.

However, as many functions of vehicles are electronically controlled, threats of vehicle cyberattacks have also increased. In order to counter these threats, intrusion detection systems that monitor and analyze communication traffic to detect intrusions are being developed. Various technologies related to intrusion detection systems have been proposed. Such technologies typically utilize limited resources. For example, an intrusion detection system may store logs of intrusions occurring in an in-vehicle network and store intrusion detection results. However, the memory capacity is typically limited

### SUMMARY

Aspects of the present disclosure provide a method and an intrusion detection system capable of efficiently storing intrusion detection results with limited resources in a vehicle.

Aspects of the present disclosure provide a method and an intrusion detection system for efficiently operating a memory within an intrusion detection system.

According to an aspect of the present disclosure, a method for storing intrusion detection results in an in-vehicle network in a vehicle is provided. The method includes detecting an intrusion into the in-vehicle network and identifying a priority for the detected intrusion. The method also includes identifying a first area in a memory for storing logs for the detected intrusion based on the identified priority and assigning an ID to the detected intrusion. The method additionally includes storing the logs for the detected intrusion in the identified first area in the memory based on the assigned ID. The method further includes determining that the detected intrusion is terminated. The method additionally includes, based on determining that the detected intrusion is terminated, terminating storage of the logs in the first area of the memory and storing result information on the detected intrusion and the ID in a second area in the memory. The memory includes the first area in which logs are stored and the second area in which intrusion detection results are stored.

The first area may be further divided into areas based on a priority for an intrusion.

The logs and the result information on the intrusion may vary depending on a type of vehicle and an attack type of the detected intrusion.

The logs may include one or more of a time at which the intrusion has occurred, a time at which the intrusion has ended, a type of attack, a component of the vehicle that is a target of the intrusion, a cause of the intrusion, or a path of the intrusion.

The result information on the detected intrusion may include at least one of an attack type of the detected intrusion or information on an alarm in the vehicle.

Sizes of areas in the first area may be determined based on a priority for an attack type.

The priority may be determined based on an attack type of the detected intrusion.

Identifying the first area in the memory for storing the logs for the detected intrusion based on the identified priority may include determining whether a size of an empty area, among areas in the first area in the memory, associated with a same priority as the identified priority is greater than a predetermined size, and based on determining that the size of the empty area is smaller than the predetermined size, deleting an area in which a log with a lowest priority is stored from the identified first area in the memory.

According to another aspect of the present disclosure, an intrusion detection system for storing intrusion detection results in an in-vehicle network in a vehicle is provided. The intrusion detection system includes a communication module, a memory, and a processor. The processor is configured to detect an intrusion into the in-vehicle network and identify a priority for the detected intrusion. The processor is also configured to identify a first area in the memory for storing logs for the detected intrusion based on the identified priority and assign an ID to the detected intrusion. The processor is further configured to store the logs for the detected intrusion in the identified first area in the memory based on the assigned ID. The processor is also configured to determine that the detected intrusion is terminated and, based on determining that the detected intrusion is terminated, terminate storage of the logs in the first area in the memory and store result information on the detected intrusion and the ID in a second area in the memory. The memory includes the first area in which logs are stored and the second area in which intrusion detection results are stored.

The first area may be further divided into areas based on a priority for an intrusion.

The logs and the result information on the intrusion may vary depending on a type of vehicle and an attack type of the detected intrusion.

The logs may include one or more of a time at which the intrusion has occurred, a time at which the intrusion has ended, a type of attack, a component of the vehicle that is a target of the intrusion, a cause of the intrusion, or a path of the intrusion.

The result information on the detected intrusion may include at least one of an attack type of the detected intrusion or information on an alarm in the vehicle.

Sizes of areas in the first area may be determined based on a priority for an attack type.

The priority may be determined based on an attack type of the detected intrusion.

The processor may be configured to determine whether a size of an empty area, among areas in the first area of the memory, associated with a same priority as the identified priority is greater than a predetermined size, and, based on determining that the size of the empty area is smaller than the predetermined size, delete an area in which a log with a lowest priority is stored from the identified first area in the memory.

### BRIEF DESCRIPTION OF THE DRAWINGS

The above and other objects, features, and advantages should become more apparent to those of ordinary skill in the art intrusion detection system from the following description taken in conjunction with the accompanying drawings, in which:

FIGS. 1A and 1B are diagrams illustrating various examples in which an intrusion detection system can be installed in an in-vehicle network, according to implementations of the present disclosure;

FIG. 2 is a flowchart of a process in which an intrusion detection system stores intrusion detection results within an in-vehicle network, according to an implementation of the present disclosure;

FIG. 3 is a configuration diagram of a memory of an intrusion detection system, according to an implementation of the present disclosure; and

FIG. 4 is a configuration diagram of an intrusion detection system, according to an implementation of the present disclosure.

The drawings described herein are for illustration purposes only and are not intended to limit the scope of the present disclosure in any way.

### DETAILED DESCRIPTION

Hereinafter, example implementations of the present disclosure are described in detail with reference to the accompanying drawings. However, it should be understood that the technical spirit of the present disclosure is not limited to the implementations disclosed below but may be implemented in many different forms. For example, it should be understood that within the scope of the present disclosure, one or more elements of each of the implementations may be selectively combined and substituted.

In addition, terms (including technical and scientific terms) used in the present disclosure have the same meanings as commonly understood by one of ordinary skill in the art to which the present disclosure pertains. It should be further understood that terms, such as those defined in commonly used dictionaries, should be interpreted as having meanings that are consistent with their meanings in the context of the related art.

Further, the terms used in the present disclosure are provided only to describe implementations of the present disclosure and not for purposes of limitation.

In this specification, the singular forms include the plural forms unless the context clearly indicates otherwise. Further, the phrase “at least one (or one or more) of an element A, an element B, and an element C,” should be understood as including the meaning of at least one of all possible combinations of the element A, the element B, and/or the element C.

Further, in describing elements of the present disclosure, terms such as “first,” “second,” “A,” “B,” “(a),” and “(b)” may be used.

These terms are used to distinguish an element from another element, but the nature, order, or sequence of the elements is not limited by these terms.

It should be understood that when an element is referred to as being “connected” or “coupled” to another element, the element may be directly connected or coupled to the other element, intervening elements may be present, or the element may be connected or coupled to the other element through still another element.

Further, when an element is described as being formed “on (above)” or “under (below)” another element, the term “on (above)” or “under (below)” includes not only a case in which two elements are in direct contact with each other, but also a case in which one or more elements are (indirectly) disposed between two elements. In addition, the term “on (above)” or “under (below)” means an upward direction as well as a downward direction based on one element.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, server, and the like may separately embody or be included with a processor and a memory, such as a non-transitory computer readable media, as part of the apparatus.

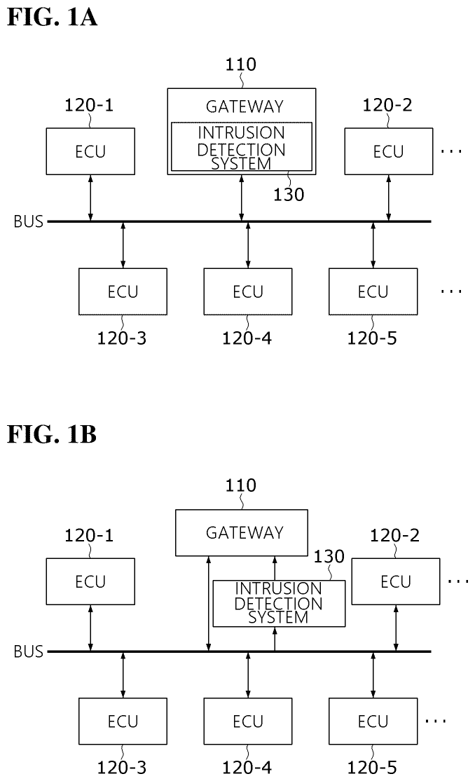

FIGS. 1A and 1B are diagrams illustrating various examples in which an intrusion detection system (IDS) can be installed within an in-vehicle network, according to implementations of the present disclosure.

Referring to FIGS. 1A and 1B, the in-vehicle network may include electronic control units (ECUs) 120-1, 120-2, 120-3, 120-4, and 120-5, a gateway 110, and an IDS 130 connected through a bus. The gateway 110 may connect an ECU that performs communication using a specific network to another network. According to an implementation, the IDS 130 may be configured as a part of the gateway 110 or may be configured as a separate device and connected to the network.

FIG. 1A illustrates an example in which an IDS 130 is configured as a part of the gateway 110, and FIG. 1B illustrates an example in which an IDS 130 is configured as a separate device and connected to the gateway 110. According to FIGS. 1A and 1B, the gateway 110 and the ECUs 120-1, 120-2, 120-3, 120-4, and 120-5 may transmit messages using the bus, and the IDS 130 may identify the messages transmitted by the gateway 110 and the ECUs 120-1, 120-2, 120-3, 120-4, and 120-5 using the bus. The IDS 130 may apply an attack detection algorithm to the identified messages to determine whether an intrusion has occurred.

The IDS 130 may store logs and/or intrusion detection results when it is determined that an intrusion has occurred in the in-vehicle network. The IDS 130 is a device included in the vehicle and may have limited resources available, and thus a method of efficiently storing logs and/or intrusion detection results may be required.

The IDS to be described below may be applied to both the IDSs described in FIGS. 1A and 1B.

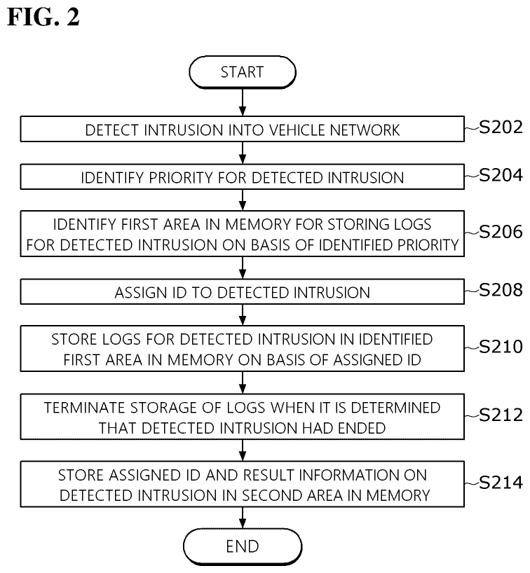

FIG. 2 is a flowchart of a process in which an IDS stores intrusion detection results within an in-vehicle network according to an implementation of the present disclosure.

Referring to FIG. 2, in an operation S202, the IDS may detect an intrusion into the in-vehicle network. The IDS may monitor data (or messages) transmitted or received within the in-vehicle network in real time. The IDS may analyze the data transmitted or received within the in-vehicle network to determine whether an intrusion has occurred. As another example, the IDS may apply an attack detection algorithm to the data transmitted or received within the in-vehicle network to determine whether an intrusion has occurred.

In an operation S204, when an intrusion is detected, the IDS may identify a priority for the detected intrusion. Priorities may be predetermined according to attack types. The attack types include a bus flooding attack, a replay attack, an ECU removal attack, etc., and priorities for these attack types may be predetermined as, for example, 1, 2, and 3. In addition, the priority may be predetermined in further consideration of at least one of whether an intrusion has an effect on the vehicle, the degree of the effect, the risk, or whether a response is possible. According to an implementation, the priority may be set to be higher as a value thereof increases, but conversely, the priority may be set to be lower as the value decreases. Further, according to an implementation, there may be a plurality of intrusions with the same priority.

In an operation S206, the IDS may identify a first area in the memory for storing logs for the detected intrusion on the basis of the identified priority. The memory of the IDS may be divided into the first area for storing logs and a second area for storing intrusion detection results. According to an implementation, the IDS may divide the areas of the memory in advance.

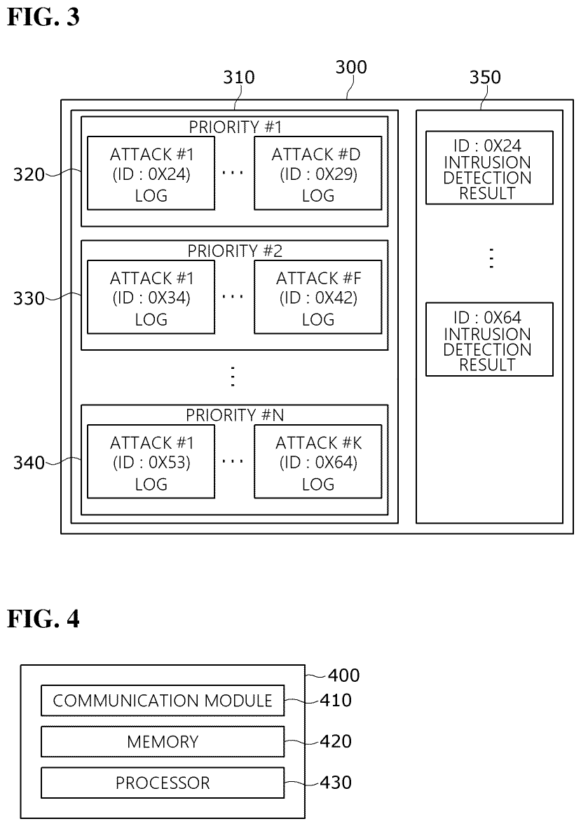

FIG. 3 is a configuration diagram of a memory of an IDS according to an implementation of the present disclosure.

Referring to FIG. 3, a memory 300 of the IDS may include a first area 310 for storing logs and a second area 350 for storing intrusion detection results. According to an implementation, the first area 310 and the second area 350 may be pre-allocated within the memory 300. Sizes of the first area 310 and second area 350 may be different, or may be the same.

According to an implementation, the first area 310 may be further divided into areas. For example, the first area 310 may be further divided into areas on the basis of a priority. Accordingly, logs for intrusions with the same priority may be stored in the same area, and logs for intrusions with different priorities may be stored in different areas. In FIG. 3, the first area 310 may include a 1-1 area 320, a 1-2 area 330, and a 1-N area 340 divided according to a priority, a log for an intrusion with priority 1 may be stored in the 1-1 area 320, a log for an intrusion with priority 2 may be stored in the 1-2 area 330, and a log for an intrusion with priority N may be stored in the 1-N area 340. Sizes of the 1-1 area 320, 1-2 area 330, and 1-N area 340 may be the same, or may be different. For example, a larger area may be allocated to store high priority logs. A plurality of logs may be stored in each of the 1-1 area 320, the 1-2 area 330, and the 1-N area 340. The logs for each intrusion may be distinguished by IDs.

According to an implementation, the logs for the intrusion may include one or more of a time at which the intrusion has occurred, a time at which the intrusion has ended, a type of attack, a component of the vehicle that is a target of the intrusion, a cause of the intrusion, or a path of the intrusion. Further, the logs for the intrusion may vary depending on a type of vehicle and a type of attack detected. For example, when the type of the detected attack has a high priority, the logs for the intrusion may be stored in more detail than when a type of attack has a lower priority.

According to an implementation, the intrusion detection results may be stored in the second area 350. When the detected intrusion is terminated, result information on the detected intrusion may be stored in the second area 350. For example, information on at least one of an ID, an attack type, alert information, an intrusion start time, an intrusion end time, an intrusion duration, or an intrusion target ECU may be stored in the second area 350 as the result information on the intrusion.

According to an implementation, the logs for the detected intrusion and the information on the intrusion detection results that are stored in the first area and the second area may vary depending on the type of vehicle and the type of attack. For example, some vehicles may not include a specific ECU, and accordingly, an intrusion may not be valid, and thus the logs and the information on the intrusion detection results that are stored in the memory may also vary.

When the memory of the IDS is pre-allocated as illustrated in FIG. 3, the IDS may rapidly perform data processing by identifying a corresponding area according to whether the information to be checked is a log or an intrusion detection result. Further, the IDS may easily check the size of the data stored in each area.

Further, according to aspects of the present disclosure, the memory of the IDS may be further divided according to a priority. In this case, when the capacity of the memory that can store data is small, information on high-priority, that is, high-risk intrusions may be stored more, which can help in resolving the intrusion. For example, when the IDS detects a high priority intrusion but the memory is all filled with data, the IDS may delete data in an area in which information on the low priority intrusion is stored, and store information on the high priority intrusion. Low priority intrusions may not be critical to the operation of the vehicle, but high priority intrusions may be critical to the operation of the vehicle and may require preemptive action.

Returning to FIG. 2, the IDS may identify a distinct area within the first area in the memory that corresponds to the identified priority. The IDS may determine (e.g., check) whether there is an empty area in which logs can be stored within the identified area. The IDS may check whether a size of the empty area is greater than a predetermined size. According to an implementation, when the size of the empty area is not larger than the predetermined size, the IDS may check whether there is an empty area within a low priority area. When there is not enough empty area within the low priority area, the IDS may delete the logs stored in the low priority area.

In an operation S208, the IDS may assign an ID to the detected intrusion. The IDS may assign IDs sequentially according to the order of intrusion. The ID may be an identifier for the detected intrusion and the IDs in the first area and the second area may be the same. The IDS may use the IDs to search for intrusions in the first area and the second area in the memory.

In an operation S210, the IDS may store the logs for the detected intrusion in the identified first area in the memory on the basis of the assigned ID. The IDS may store the logs together with the assigned ID in the first area in the memory. The IDS may store at least some pieces of data (or communication packets) transmitted or received within the network as the logs. The IDS may determine the data to be stored as the logs in consideration of the type of vehicle. For example, when the vehicle has high specifications and the memory capacity is sufficiently large, the IDS may store a large amount of data as the logs. Further, when the vehicle has high specifications, the types of ECUs included in the vehicle may be diverse, and thus the IDS may store all data indicating that the detected intrusion can affect the ECUs included in the vehicle as the logs.

According to an implementation, the IDS may store logs for a certain period of time before an intrusion occurs.

In an operation S212, the IDS may terminate the storage of the logs when it is determined that the detected intrusion had ended. According to an implementation, the IDS may store logs for a certain period of time after the intrusion has ended.

In an operation S214, the IDS may store the assigned ID and the result information on the detected intrusion in the second area in the memory. After it is determined that the intrusion has ended or after the storage of the log is terminated, the IDS may store the result information on the detected intrusion together with the assigned ID in the second area in the memory. The IDS may check whether there is enough empty space in the second area in the memory before storing the result information on the detected intrusion in the second area in the memory. The IDS may check whether the size of the empty space of the second area in the memory is greater than a predetermined size, and when it is determined that the size of the empty space of the second area in the memory is not greater than a predetermined size, may delete result information on a low priority intrusion from the second area in the memory.

According to an implementation, the IDS may determine the result information on the intrusion to be stored in consideration of the type of vehicle. For example, when the vehicle has high specifications and the memory capacity is sufficiently large, the IDS may store a large amount of data as the result information on the intrusion. However, when the vehicle has low specifications, the memory capacity may also be small, and thus only minimum information may be stored as the result information on the intrusion.

According to an implementation, the result information on the detected intrusion may include, for example, at least one of an attack type, alert information, an intrusion start time, an intrusion end time, an intrusion duration, or an intrusion target ECU.

FIG. 4 is a configuration diagram of an intrusion detection system according to an implementation of the present disclosure.

Referring to FIG. 4, an IDS 400 may include a communication module 410, a memory 420, and a processor 430.

The communication module 410 may enable the IDS 400 to check data transmitted or received by other ECUs or a gateway. For example, when the communication module 410 supports a CAN network, the communication module 410 may check a bus to check the transmitted or received data.

The memory 420 may store logs and intrusion detection results. Since the structure of the memory 420 is described in detail with reference to FIG. 3, a description thereof has been omitted here. According to an implementation, the memory 420 may further store attack types and their corresponding priorities.

The processor 430 may by and large control the IDS 400. The processor 430 may control the communication module 410 and operate the memory 420. According to an implementation, the processor 430 may detect an intrusion into an in-vehicle network. For example, the processor 430 may find a specific pattern that can distinguish between normal and abnormal states in the data checked through the communication module 410. As another example, the processor 430 may detect the intrusion by applying an attack detection algorithm to the data checked through the communication module 410.

When an intrusion is detected, the processor 430 may identify a priority for the detected intrusion. According to an implementation, since priorities according to attack types may be stored in the memory 420, the processor 430 may check the attack type of the detected intrusion to identify the priority. According to an implementation, the priorities according to the attack types may be as shown in Table 1.

TABLE 1

| Attack type | Priority |
|---|---|
| Electronic control unit removal attack | 3 |
| Bus flooding attack | 1 |
| Replay attack | 2 |

The processor 430 may identify a first area in the memory 420 for storing logs for the detected intrusion on the basis of the identified priority. The first area in the memory 420 may be an area for storing logs, and areas for storing the logs may be further divided based on the priority according to the attack type. In other words, the areas for storing the logs may be different in the first area in the memory 420 based on the priority according to the attack type, and thus the processor 430 may identify the first area in the memory 420 for storing the logs.

According to an implementation, when the processor 430 does not secure enough area corresponding to the priority of the first area in the memory 420 for storing the logs, the processor 430 may delete the logs of the area in which the logs with a low priority are stored in the first area in the memory 420 to secure an empty area in the first area in the memory 420. When identifying the first area in the memory 420, the processor 430 may check the size of the first area.

The processor 430 may assign an ID to the detected intrusion. The assigned ID is for identifying the detected intrusion and may be a unique value in the first and second areas in the memory 420. When confirming the detected intrusion, the processor 430 may use the ID to check the logs in the first area in the memory 420 and check the intrusion detection results in the second area.

The processor 430 may store the logs for the detected intrusion on the basis of the ID assigned to the identified first area in the memory. The processor 430 may select an item of information to be stored as a log in consideration of the type of vehicle and/or the type of intrusion. For example, the processor 430 may store related logs when the type of vehicle includes a specific function or a specific ECU. Further, the processor 430 may store many types of data as a log when the priority of the attack type is high.

The processor 430 may terminate the storage of the logs when it is determined that the detected intrusion has ended.

According to an implementation, the processor 430 may store the logs from a certain period of time before the intrusion occurs to a certain period of time after the intrusion has ended.

The processor 430 may store the assigned ID and the result information on the detected intrusion in the second area in the memory 420. The processor 430 may select an item of the result information on the detected intrusion in consideration of the type of vehicle and/or the type of intrusion. According to an implementation, the result information on the detected intrusion may include, for example, at least one of an attack type, alert information, an intrusion start time, an intrusion end time, an intrusion duration, or an intrusion target ECU.

According to implementations of the present disclosure, the IDS can efficiently store logs and intrusion detection results.

Further, according to implementations of the present disclosure, the IDS can efficiently operate an internal memory.

While the present disclosure has been particularly described with reference to the example implementations of the present disclosure, the implementations are merely illustrative implementations of the present disclosure. It should be understood by those having ordinary skill in the art that modified examples and applications in other forms may be made without departing from the spirit and scope of the present disclosure. For example, each component specifically shown in the implementations may be modified and embodied. In addition, it should be understood that differences related to these modified examples and applications are within the scope of the present disclosure as defined in the appended claims.

What is claimed is:

1. A method for storing intrusion detection results in an in-vehicle network in a vehicle, the method comprising:
detecting an intrusion into the in-vehicle network;
identifying a priority for the detected intrusion;
identifying a first area in a memory for storing logs for the detected intrusion based on the identified priority;
assigning an identifier (ID) to the detected intrusion;
storing the logs for the detected intrusion in the identified first area in the memory based on the assigned ID;
determining that the detected intrusion is terminated; and
based on determining that the detected intrusion is terminated, terminating storage of the logs in the first area in the memory and storing result information on the detected intrusion and the ID in a second area in the memory,
wherein the memory includes the first area in which logs are stored and the second area in which intrusion detection results are stored.

2. The method of claim 1, wherein the first area is further divided into areas based on a priority for an intrusion.

3. The method of claim 1, wherein the logs and the result information on the intrusion vary depending on a type of vehicle and an attack type of the detected intrusion.

4. The method of claim 3, wherein the logs include one or more of a time at which the intrusion has occurred, a time at which the intrusion has ended, a type of attack, a component of the vehicle that is a target of the intrusion, a cause of the intrusion, or a path of the intrusion.

5. The method of claim 1, wherein the result information on the detected intrusion includes at least one of an attack type of the detected intrusion or information on an alarm in the vehicle.

6. The method of claim 1, wherein sizes of areas in the first area are determined based on a priority for an attack type.

7. The method of claim 1, wherein the priority is determined based on an attack type of the detected intrusion.

8. The method of claim 1, wherein identifying the first area in the memory for storing the logs for the detected intrusion based on the identified priority includes:
determining whether a size of an empty area, among areas in the first area in the memory, associated with a same priority as the identified priority is greater than a predetermined size; and
based on determining that the size of the empty area is smaller than the predetermined size, deleting an area in which a log with a lowest priority is stored from the identified first area in the memory.

9. An intrusion detection system for storing intrusion detection results in an in-vehicle network in a vehicle, the intrusion detection system comprising:
a communication module;
a memory; and
a processor configured to:
detect an intrusion into the in-vehicle network,
identify a priority for the detected intrusion,
identify a first area in the memory for storing logs for the detected intrusion based on the identified priority,
assign an identifier (ID) to the detected intrusion,
store the logs for the detected intrusion in the identified first area in the memory based on the assigned ID,
determine that the detected intrusion is terminated, and
based on determining that the detected intrusion is terminated, terminate storage of the logs in the first area in the memory and store result information on the detected intrusion and the ID in a second area in the memory,
wherein the memory includes the first area in which logs are stored and the second area in which intrusion detection results are stored.

10. The intrusion detection system of claim 9, wherein the first area is further divided into areas based on a priority for an intrusion.

11. The intrusion detection system of claim 9, wherein the logs and the result information on the intrusion vary depending on a type of vehicle and an attack type of the detected intrusion.

12. The intrusion detection system of claim 11, wherein the logs include one or more of a time at which the intrusion has occurred, a time at which the intrusion has ended, a type of attack, a component of the vehicle that is a target of the intrusion, a cause of the intrusion, or a path of the intrusion.

13. The intrusion detection system of claim 9, wherein the result information on the detected intrusion includes at least one of an attack type of the detected intrusion or information on an alarm in the vehicle.

14. The intrusion detection system of claim 9, wherein sizes of areas in the first area are determined based on a priority for an attack type.

15. The intrusion detection system of claim 9, wherein the priority is determined based on an attack type of the detected intrusion.

16. The intrusion detection system of claim 9, wherein the processor is configured to:
determine whether a size of an empty area, among areas in the first area in the memory, associated with a same priority as the identified priority is greater than a predetermined size; and
based on determining that the size of the empty area is smaller than the predetermined size, delete an area in which a log with a lowest priority is stored from the identified first area in the memory.
